(19) United States
(12) Patent Application Publication
(10) Pub. No.: US 2018/0363661 A1
(43) Pub. Date: Dec. 20, 2018

(54) FAN WHEEL FOR AN AXIAL FAN

(71) Applicant: Mahle International GmbH, Stuttgart (DE)

(72) Inventor: Stephanie Larpent, Stuttgart (DE)

(73) Assignee: Mahle International GmbH, Stuttgart (DE)

(21) Appl. No.: 15/781,126

(22) PCT Filed: Nov. 29, 2016
(86) PCT No.: PCT/EP2016/079122

§ 371 Date: Jun. 2, 2018

(30) Foreign Application Priority Data
Dec. 2, 2015 (DE) 10 2015 224 096.7

(51) Int. Cl. F04D 19/00; F04D 29/38

(52) U.S. Cl. CPC F04D 19/002; F04D 29/384; F05D 2250/71; F05D 2240/307; F05D 2240/301

(57) ABSTRACT

A fan wheel for an axial fan may include a hub and a plurality of blades extending from the hub. Each blade of the plurality of blades may include a blade root coupled to the hub, a blade tip radially distant from the hub, a blade central region lying radially between the blade root and the blade tip, a blade front side facing a pressure side, a blade back side facing a suction side, a transverse profile lying in a cross-sectional plane extending perpendicularly to a radial direction, and a transverse curvature in the transverse profile configured such that the blade front side is curved concavely toward the pressure side and the blade back side is curved convexly toward the suction side. The transverse curvature of at least one blade of the plurality of blades may decrease from the blade central region to the blade tip.

### CROSS-REFERENCE TO RELATED APPLICATIONS

This application claims priority to International Patent Application No. PCT/EP2016/079122, filed on Nov. 29, 2016, and German Patent Application No. DE 10 2015 224 096.7, filed on Dec. 2, 2015, the contents of both of which are hereby incorporated by reference in their entirety.

### TECHNICAL FIELD

The present invention relates to a fan wheel for an axial fan for producing a cooling air flow, preferably for a vehicle radiator. The invention relates, in addition, to an axial fan equipped with such a fan wheel.

### BACKGROUND

From DE 10 2010 042 325 A1 a fan wheel is known which has a hub from which a plurality of blades extends. Each blade has, radially inside, a blade root connected to the hub and, radially outside, a blade tip distant from the hub. In addition, each blade has a blade front side, which faces a pressure side of the fan wheel, a blade back side, which faces a suction side of the fan wheel, and a transverse profile, which lies in a cross-sectional plane extending perpendicularly to the radial direction. The blades have in the transverse profile respectively a curvature which is designated in the following as a transverse curvature. The transverse curvature causes the blade front side to be curved concavely toward the pressure side in the transverse profile, while the blade back side is curved convexly toward the suction side in the transverse profile.

An axial fan which is equipped with such a fan wheel can have a fan cover or fan shroud, which is equipped with a casing. In the mounted state, the fan cover forms a flow channel which leads from a vehicle radiator to the fan wheel, which is arranged coaxially in the casing, so that the casing encloses or surrounds the fan wheel in circumferential direction. A radial gap is formed radially between the casing and the blade tips of the fan wheel, to prevent a collision. It has been found that with efficient fan wheels during operation of the axial fan, a comparatively great pressure difference occurs between the suction side and the pressure side of the fan wheel. It can occur here on the blades that through said radial gap a gap flow occurs from the front side to the back side around the respective blade tip. In the case of an unfavourable combination of installation situation and current operating state, this gap flow can lead to the fan wheel becoming unstable. With an unstable fan wheel, a noise development and/or deviations can be brought about within a characteristic which defines an association between rotation speed and conveying capacity of the fan wheel.

### SUMMARY

The present invention is concerned with the problem of indicating for a fan wheel of the type described above, or respectively for an axial fan equipped therewith, an improved embodiment which is distinguished by an improved stability of the fan wheel.

This problem is solved according to the invention by the subject of the independent claim(s). Advantageous embodiments are the subject of the dependent claim(s).

The invention is based on the general idea of reducing the transverse curvature of the transverse profile in the region of the blade tip, at least in the case of one blade, preferably of all the blades of the fan wheel. It has been found that a reduction of the transverse curvature in the region of the blade tip reduces the pressure difference between blade front side and blade back side at the blade tip, whereby the formation of the undesired gap flow is impeded. As the transverse curvature of the blades has a significant influence on the conveying capacity of the fan wheel, the reduction of the curvature in the region of the blade tip is accompanied by a loss of conveying capacity. In order to compensate for this loss, the invention additionally proposes enlarging the transverse curvature of the respective blade in a blade central region which lies radially between the blade root and the blade tip. To prevent an aerodynamically unfavourable jump in the course of the blade front side and/or of the blade back side, the invention finally proposes configuring the transverse curvature so that it decreases from the blade central region to the blade tip. Expediently, the transverse curvature decreases continuously here. Ideally, therefore, a fan wheel can be provided which, on the one hand, shows an efficient conveying capacity, while on the other hand it is distinguished by a reduced instability.

In the present context, the “radial direction”, the “axial direction” and the “circumferential direction” refer to a rotation axis of the fan wheel. The rotation axis defines the axial direction, i.e. the axial direction extends parallel to the rotation axis. The radial direction stands perpendicularly to the axial direction and the circumferential direction rotates perpendicularly to the radial direction about the rotation axis.

The transverse curvature can be constant from the blade central region to the blade root or can also decrease. Therefore, the transverse curvature from the blade root to the blade tip can either be constant up to the blade central region and then decrease up to the blade tip, or else can only increase up to the blade central region and then decrease up to the blade tip. In so far as the transverse curvature decreases from the blade central region to the blade root, this decrease is smaller inward than the decrease outward, which is provided from the blade central region to the blade tip. In other words, in this case the transverse curvature is smaller at the blade tip than at the blade root.

The blades have, in addition, a leading edge facing the suction side, a trailing edge facing the pressure side, and a longitudinal profile which lies in a longitudinal section plane extending parallel to the radial direction. In conventional fan wheels, this longitudinal profile is usually non-curved or respectively is configured so as to be rectilinear. In contrast thereto, the present invention for an advantageous embodiment proposes that at least one blade, preferably each blade, has in the longitudinal profile a curvature which is designated in the following as longitudinal curvature. This longitudinal curvature is configured so that the blade back side is curved convexly toward the suction side. It has been found that in this way on the one hand the desired decrease of the transverse curvature from the blade central region to the blade tip can be realized in a simplified manner. On the other hand, this geometry also contributes to the lowering of the pressure difference between front side and back side in the region of the blade tip, which additionally impedes the formation of the undesired radial flow.

In an advantageous further development, the blade front side can be curved concavely toward the pressure side in the region of the longitudinal curvature. This provision also assists on the one hand the decrease of the transverse curvature from the blade central region to the blade tip, and on the other hand the reduction of the pressure difference between blade front side and blade back side in the region of the blade tip.

In another advantageous further development, the longitudinal curvature can extend at least from the blade central region to the blade tip. Hereby, the above-mentioned effects are intensified.

Basically, this longitudinal curvature can extend over the entire radial length of the respective blade, therefore virtually from the blade root to the blade tip. However, an embodiment is preferred in which the longitudinal curvature extends only from the blade central region to the blade tip. A further development is then particularly advantageous, in which the longitudinal profile extends in a non-curved or respectively rectilinear manner from the blade central region to the blade root on the blade back side and/or on the blade front side. This structural shape is based on the consideration that the advantageous effect of the longitudinal curvature on the reduction of the gap flow already arises when the longitudinal curvature extends only from the blade central region to the blade tip. In connection with the non-curved or respectively rectilinear configuration of the longitudinal profile from the blade central region to the blade root, the efficiency of the fan wheel can then be improved with regard to its conveying capacity.

In another advantageous embodiment, the longitudinal curvature can extend at least in a central region of the transverse profile, which lies in the transverse profile between the leading edge and the trailing edge. Hereby, the intended effect by means of the longitudinal curvature occurs particularly clearly. In the central region, the longitudinal section plane extends substantially perpendicularly to the axial direction, wherein the wording “substantially” permits deviations to the perpendicular arrangement of ±15°.

According to another advantageous embodiment, provision can be made that the longitudinal curvature extends only in a central region of the transverse profile which lies in the transverse profile between the leading edge and the trailing edge. Through this provision, disadvantageous effects in the region of the leading edge and/or in the region of the trailing edge can be reduced, which can be caused there by such a longitudinal curvature.

In a further embodiment, provision can be made that a radius of curvature of the transverse curvature increases from the blade central region to the blade tip. Expediently, the radius of curvature increases here continuously or respectively constantly. For example, the radius of curvature can increase from the blade central region to the blade tip in a range of 5% to 20%. Preferably, the radius of curvature increases from the blade central region to the blade tip in a range of 5% to 10%.

The blade central region is spaced apart, radially inside, from the blade root and, radially outside, from the blade tip and is arranged expediently radially centrally between blade root and blade tip. The blade central region can extend here over a maximum of half, preferably over a maximum of a third, of the blade length measured in the radial direction. This means that the outer region of the respective blade, lying radially on the outside, extending from the blade central region to the blade tip, extends over at least a quarter of the blade length. In this outer region, the radially outwardly decreasing transverse curvature is present in the transverse profile.

Maximally the outer region therefore extends over 75% of the blade length. Preferably, the outer region extends over 40% to 60%, in particular over approximately 50% of the blade length.

In another advantageous embodiment, provision is made that all the blades extend from the hub in freestanding manner. This means that the blades are not connected to one another, apart from via the hub. In particular, no cover band is provided, which connects the blade tips of adjacent blades to one another.

An axial fan according to the invention is suitable for producing a cooling air flow for a vehicle radiator and is equipped with a fan wheel of the type described above. In addition, the axial fan has a fan shroud or fan cover, which has a casing which encloses the fan wheel in circumferential direction. Here, the fan cover and fan wheel are arranged with respect to one another so that a radial gap is formed radially between the casing and the blade tips.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively diagrammatically,

FIG. 1 an isometric partial view onto a suction side of a fan wheel of an axial fan,

FIG. 2 an isometric view onto the suction side of the fan wheel in the region of a blade,

FIG. 3 an isometric complete view onto the suction side of the fan wheel,

FIG. 4 an axial view onto the axial side of the fan wheel in the region of a blade,

FIG. 5 a cross-section of the blade of FIG. 4 according to section lines V in FIG. 4,

FIG. 6 a cross-section of the blade of FIG. 4 according to section lines VI in FIG. 4.

### DETAILED DESCRIPTION

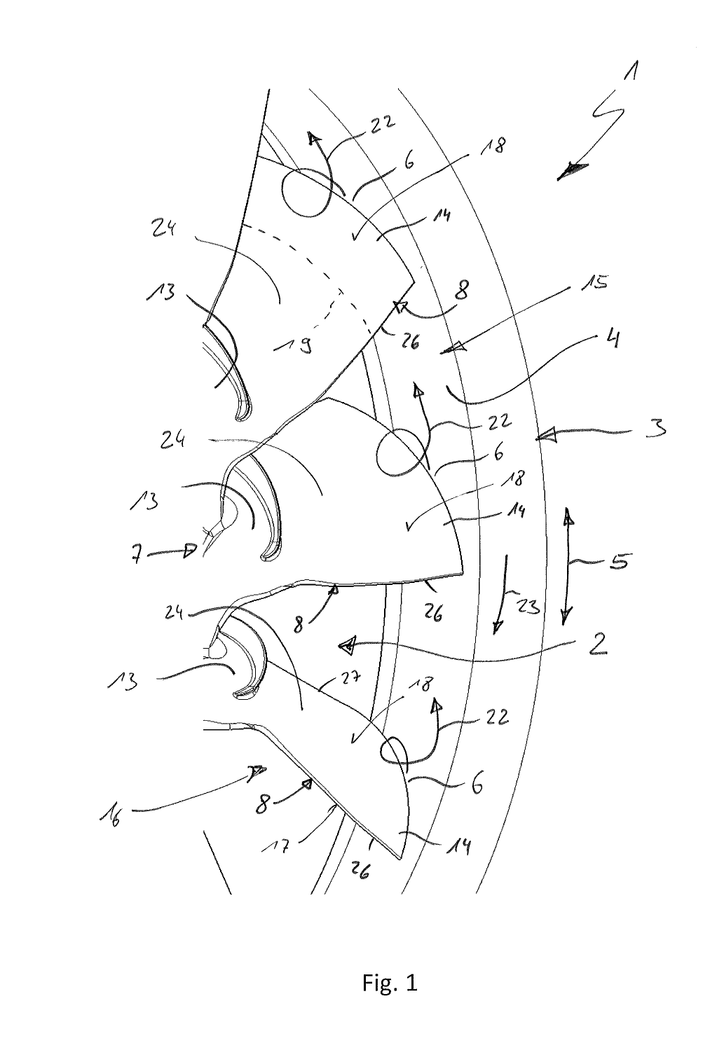

According to FIG. 1, an axial fan 1, which is only partially illustrated, by means of which a cooling air flow can be produced for a vehicle radiator, comprises a fan wheel 2 and a fan cover 3. The fan cover 3, which can also be designated as a fan shroud, directs, in the mounted state of the axial fan 1, the cooling air flow produced by means of the fan wheel 2 from the vehicle radiator to the fan wheel 2. The fan cover 3 has a casing 4, which encloses the fan wheel 2 in a circumferential direction 5, which is indicated in FIG. 1 by a double arrow. A radial gap 6 is formed radially between the casing 4 and the fan wheel 2.

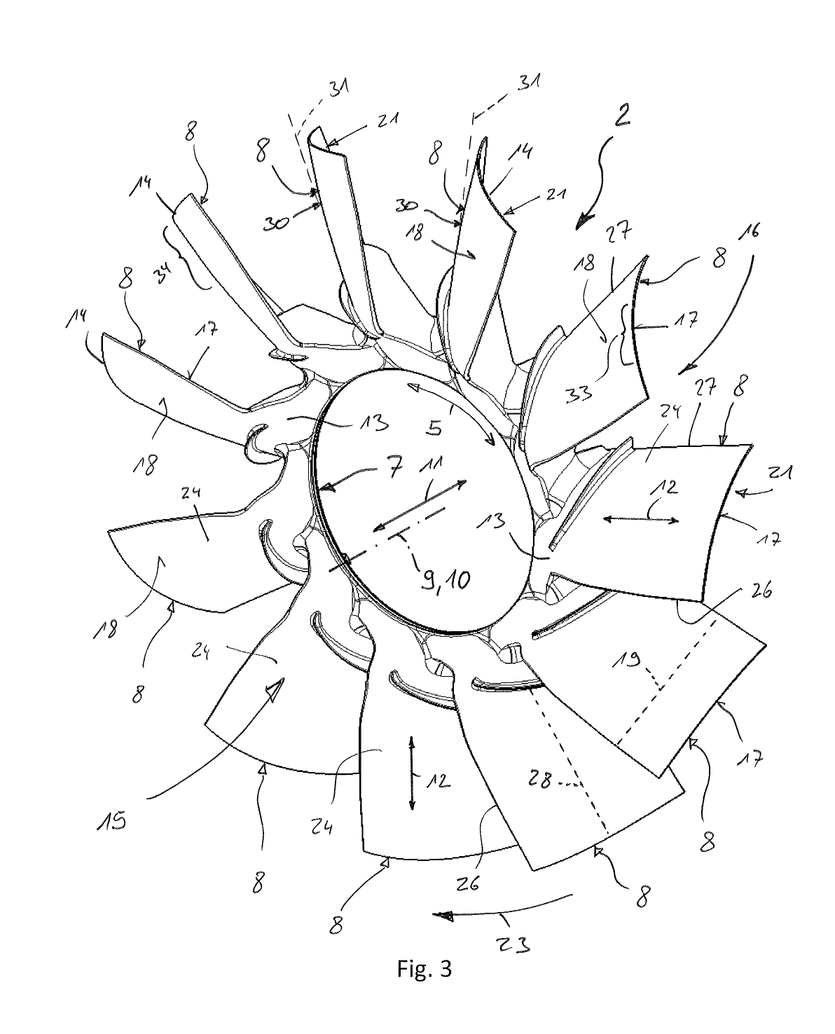

As can be seen in particular from FIG. 3, the fan wheel 2 has a hub 7 and a plurality of blades 9 projecting substantially radially from the hub 7. The fan wheel 2 with the hub 7 and the blades 8 can be formed by a one-piece injection-moulded part from plastic or metal, in particular light metal.

The fan wheel 2 has a longitudinal centre axis 9, with respect to which the fan wheel 2 is configured rotationally symmetrically. In the installed state of the fan wheel 2, the longitudinal centre axis 9 forms a rotation axis 10 of the fan wheel 2. This rotation axis 10 defines an axial direction 11, which is indicated in the figures by a double arrow. Perpendicularly to the rotation axis 10 a radial direction 12 extends, which is indicated in the figures for individual blades 8 respectively by a double arrow. The circumferential direction 5 also relates to the rotation axis 10.

According to FIGS. 1 to 4, each blade 8 has radially inside a blade root 13, which is connected to the hub 7, and radially outside a blade tip 14, which is distant from the hub 7. The fan wheel 2 has a suction side 15, which faces the observer in FIGS. 1 to 4. In the mounted state, this suction side 15 faces the vehicle radiator. Furthermore, the fan wheel 2 has a pressure side 16, which faces away from the observer in FIGS. 1 to 4. The pressure side 16 and suction side 14 form axial sides of the fan wheel 2, which face away from one another.

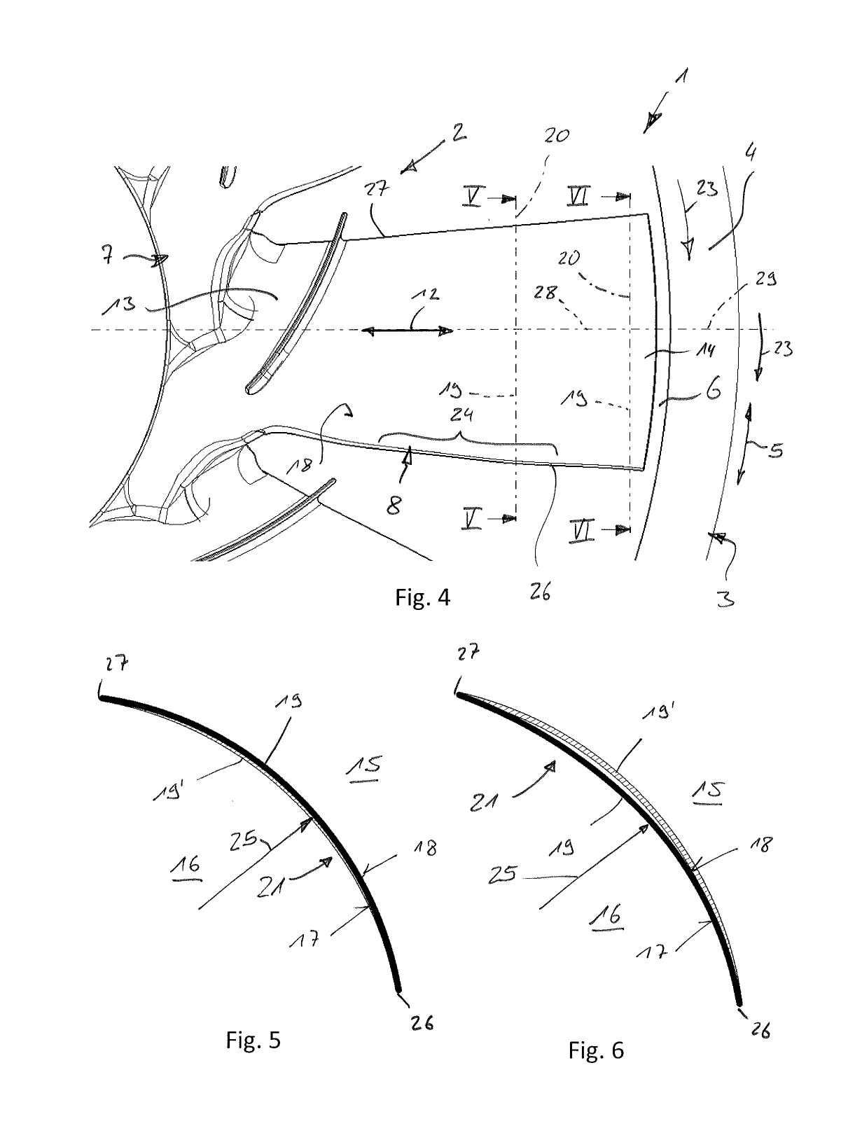

Each blade 8 has a blade front side 16 facing the pressure side 16, and a blade back side 18 facing the suction side 15. In addition, each blade 8 has a transverse profile 19, which in FIGS. 1 to 4 is indicated by a broken line respectively for at least one blade 8, and which lies in a cross-sectional plane 20, which is indicated by a broken line in FIG. 4. The cross-sectional plane 20 extends here perpendicularly to the radial direction 12. In FIGS. 5 and 6 such a transverse profile 19 can also be seen. In FIGS. 5 and 6, the cross-sectional plane 20 lies in the plane of the drawing.

In addition, each blade 5 has in the transverse profile 19 a transverse curvature 21. This transverse curvature 21 causes the respective blade front side 17 in the cross-sectional profile 19 to be curved concavely toward the pressure side 16. At the same time, the respective blade back side 18 in the cross-sectional profile 19 is curved concavely toward the suction side 15.

According to FIG. 1, the radial gap 6 is therefore situated radially between the casing 4 and the respective blade tip 14. During the operation of the axial fan 1, therefore on rotation of the fan wheel 2, through the radial gap 6 a gap flow 22 can occur, which is indicated in FIG. 1 in a simplified manner by flow arrows. A rotation direction of the fan wheel 2 is indicated here by an arrow 23.

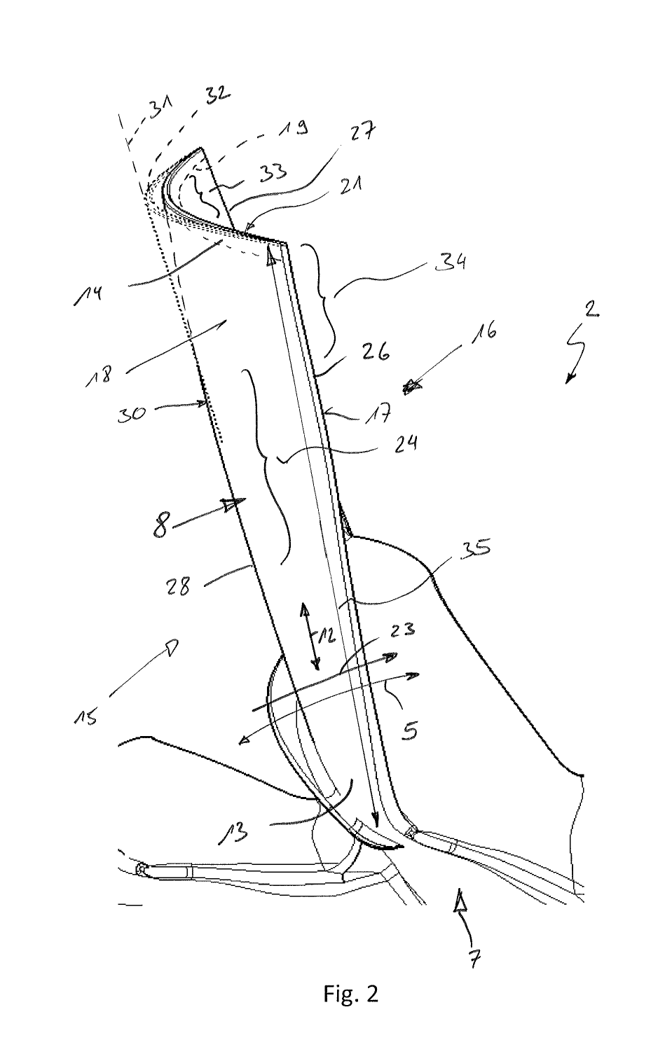

In order to reduce or respectively minimize these gap flows 22 during the operation of the fan wheel 2, provision is made with regard to the blades 8 that the transverse curvature 21 of the transverse profile 19 decreases from a blade central region 24 to the blade tip 14. This blade central region 24 lies here radially between the blade root 13 and the blade tip 14. The transverse curvature 21, decreasing in the direction of the blade tip 14, can be seen in a particular manner in FIGS. 2 and 4 to 6. Thus, FIG. 5 shows a sectional view according to section lines V of FIG. 4, which corresponds to a cross-section of the blade 8 in the blade central region 24. Compared thereto, FIG. 6 shows a cross-section according to section lines VI in FIG. 4, which lies in the region of the blade tip 14. Therefore, in the transverse profile 19 according to the cross-section of FIG. 5 the transverse curvature 21 is noticeably larger than in the transverse profile 19 of the cross-section according to FIG. 6. In particular, therefore, a radius of curvature 25 in the transverse profile 19 of FIG. 5 is smaller than in the transverse profile 19 of FIG. 6. The greater the radius of curvature 25, the smaller is the transverse curvature 21.

In FIGS. 5 and 6, the transverse profile 19 according to the invention is depicted by a filled-in black contour. Compared thereto, a conventional transverse profile 19′ is illustrated in FIGS. 5 and 6 by a hatched contour, which has a constant transverse curvature 21 from the blade central region 24 to the blade tip 14 and a constant radius of curvature 25. In the blade central region 24, the curvature 21 according to FIG. 5 in the transverse profile 19 presented here is noticeably more strongly pronounced than in the conventional transverse profile 19′. In contrast thereto, according to FIG. 6 in the transverse profile 19 which is presented here, the curvature 21 is more weakly pronounced than in the conventional transverse profile 19′.

Through the reduced transverse curvature 19 in the region of the blade tip 14, the previously mentioned gap flow 22 can be reduced. The reduction of the gap flow 22 increases the stability of the fan wheel 2 in operation. The increase of the transverse curvature 19 in the blade central region 24 compensates for the drop in efficiency of the fan wheel 2, which occurs through the reduced transverse curvature 19 in the region of the blade tips 14.

According to FIGS. 1 to 4, each blade 8 has a leading edge 26 facing the suction side 15, a trailing edge 27 facing the pressure side 16, and a longitudinal profile 28, which in FIGS. 1 to 4 respectively is indicated in the case of at least one blade 8 by means of a broken line. The longitudinal profile 28 lies here in a longitudinal section plane 29, which is indicated by a broken line in FIG. 4 and which extends parallel to the radial direction 12.

As can be seen from FIGS. 2 and 3, the blades 8 are equipped here in addition in the longitudinal profile 28 respectively with a longitudinal curvature 30. This longitudinal curvature 30 causes the respective blade back side 18 to be curved convexly toward the suction side 15. For clarification of this convex longitudinal curvature 30 with regard to the suction side, on the blade back side 18, in FIGS. 2 and 3 respectively a comparative straight line 31 is drawn by a broken line, which represents the course of a non-curved, rectilinear blade back side 18 in the respective longitudinal profile 28. In FIG. 2 in addition a contour 32 is indicated with a broken line, which occurs in the region of the blade tip 14 in a conventional blade 8, in which on the one hand in the longitudinal profile 28 no longitudinal curvature 30 is provided, and in which on the other hand the transverse curvature 21 is constant from the blade central region 24 to the blade tip 14.

Expediently, the blade front side 17 is concavely curved toward the pressure side 16 in the region of the longitudinal curvature 30.

In the examples shown here, the longitudinal curvature 30 extends only from the blade central region 24 to the blade tip 14. In addition, in the example shown here, provision is made that the longitudinal profile 28 extends in a rectilinear manner from the blade central region 24 to the blade root 13 at least on the blade back side 18. In addition, provision is made here that the longitudinal curvature 30 extends at least in a central region 33 of the transverse profile 19. This central region 33 lies here in the transverse profile 19 between the leading edge 26 and the trailing edge 27. An embodiment is preferred here in which the longitudinal curvature 30 extends only in this central region 33.

The blade central region 24 extends maximally over 50% of a radially measured blade length, which is indicated in FIG. 2 and is designated by 35, and is arranged in the radial direction 12 centrally between blade root 13 and blade tip 14. Accordingly, an outer region 34, indicated in FIG. 2, begins here at the blade central region 24 and extends up to the blade tip 14, wherein the outer region 34 comprises the blade tip 14. In this outer region 34, the decreasing transverse curvature 21 is contained in the transverse profile 19. In addition, preferably the longitudinal curvature 30 is formed in this outer region 34. This outer region 23 extends over at least 25% of the blade length 35 measured in the radial direction 12. The outer region 34 can occupy maximally 50% of the blade length 35. The blade central region 34 then lies precisely in the centre on 50% of the blade length 35.

As can be seen in particular from FIG. 3, all the blades 8 are arranged in a freestanding manner, so that they are connected to one another only via the hub 7.

1. A fan wheel for an axial fan for producing a cooling air flow, comprising:
a hub;
a plurality of blades extending from the hub, each blade of the plurality of blades including, radially inside, a blade root coupled to the hub and, radially outside, a blade tip distant from the hub;
each blade having a blade front side facing a pressure side, a blade back side facing a suction side, and a transverse profile lying in a cross-sectional plane extending perpendicularly to a radial direction;
each blade having a transverse curvature in the transverse profile configured such that the blade front side is curved concavely toward the pressure side in the transverse profile and the blade back side is curved convexly toward the suction side in the transverse profile;
wherein each blade has a blade central region lying radially between the blade root and the blade tip; and
wherein the transverse curvature of the transverse profile of at least one blade of the plurality of blades decreases from the blade central region to the blade tip.

2. The fan wheel according to claim 1, wherein the transverse curvature is constant from the blade central region to the blade root.

3. The fan wheel according to claim 1, wherein the transverse curvature decreases from the blade central region to the blade root.

4. The fan wheel according to claim 3, wherein the transverse curvature decreases more intensively from the blade central region to the blade tip than from the blade central region to the blade root.

5. The fan wheel according to claim 3, wherein the transverse curvature is smaller at the blade tip than at the blade root.

6. The fan wheel according to claim 1, wherein:
each blade has a leading edge facing the suction side, a trailing edge facing the pressure side, and a longitudinal profile lying in a longitudinal section plane extending parallel to the radial direction; and
at least one blade of the plurality of blades has, in the longitudinal profile, a longitudinal curvature configured such that the blade back side is curved convexly toward the suction side.

7. The fan wheel according to claim 6, wherein, in the longitudinal profile, in a region of the longitudinal curvature the blade front side is concavely curved toward the pressure side.

8. The fan wheel according to claim 6, wherein the longitudinal curvature extends at least from the blade central region to the blade tip.

9. The fan wheel according to claim 6, wherein the longitudinal curvature extends only from the blade central region to the blade tip and the longitudinal profile is rectilinear from the blade central region to the blade root at least on the blade back side.

10. The fan wheel according to claim 6, wherein the longitudinal curvature extends at least in a central region of the transverse profile lying in the transverse profile between the leading edge and the trailing edge.

11. The fan wheel according to claim 6, wherein the longitudinal curvature extends only in a central region of the transverse profile lying in the transverse profile between the leading edge and the trailing edge.

12. The fan wheel according to claim 1, wherein a radius of curvature of the transverse curvature increases from the blade central region to the blade tip.

13. The fan wheel according to claim 1, wherein a radius of curvature of the transverse curvature increases from the blade central region to the blade root.

14. The fan wheel according to claim 1, wherein the plurality of blades extend from the hub in a freestanding manner.

15. An axial fan for producing a cooling air flow for a vehicle radiator, comprising:
a fan wheel including:
a hub; and
a plurality of blades extending from the hub, each blade of the plurality of blades including a blade root coupled to the hub, a blade tip radially distant from the hub, a blade central region lying radially between the blade root and the blade tip, a blade front side facing a pressure side, a blade back side facing a suction side, a transverse profile lying in a cross-sectional plane extending perpendicularly to a radial direction, and a transverse curvature in the transverse profile configured such that the blade front side is curved concavely toward the pressure side in the transverse profile and the blade back side is curved convexly toward the suction side in the transverse profile;
wherein the transverse curvature of the transverse profile of at least one blade of the plurality of blades decreases from the blade central region to the blade tip;
a fan cover including a casing enclosing the fan wheel in a circumferential direction; and
wherein a radial gap is defined radially between the casing and the blade tip of each blade of the plurality of blades.

16. The axial fan according to claim 15, wherein the transverse curvature decreases from the blade central region to the blade root.

17. The axial fan according to claim 16, wherein the transverse curvature decreases more intensively from the blade central region to the blade tip than from the blade central region to the blade root.

18. The axial fan according to claim 15, wherein:
each blade has a leading edge facing the suction side, a trailing edge facing the pressure side, and a longitudinal profile lying in a longitudinal section plane extending parallel to the radial direction; and
at least one blade of the plurality of blades has, in the longitudinal profile, a longitudinal curvature configured such that the blade back side is curved convexly toward the suction side.

19. A fan wheel for an axial fan, comprising:
a hub; and
a plurality of blades extending from the hub, each blade of the plurality of blades including a blade root coupled to the hub, a blade tip radially distant from the hub, a blade central region lying radially between the blade root and the blade tip, a blade front side facing a pressure side, a blade back side facing a suction side, a leading edge facing the suction side, a trailing edge facing the pressure side, a transverse profile lying in a cross-sectional plane extending perpendicularly to a radial direction, a transverse curvature in the transverse profile configured such that the blade front side is curved concavely toward the pressure side in the transverse profile and the blade back side is curved convexly toward the suction side in the transverse profile, and a longitudinal section plane extending parallel to the radial direction;
wherein the transverse curvature of the transverse profile of at least one blade of the plurality of blades decreases from the blade central region to the blade tip and from the blade central region to the blade root; and
wherein the longitudinal curvature of the longitudinal profile of at least one blade of the plurality of blades is configured such that the blade back side is curved convexly toward the suction side.

20. The fan wheel according to claim 19, wherein the longitudinal curvature extends only from the blade central region to the blade tip and the longitudinal profile is rectilinear from the blade central region to the blade root at least on the blade back side.
